(19) United States
(12) Patent Application Publication
(10) Pub. No.: US 2007/0174198 A1
(43) Pub. Date: Jul. 26, 2007

(54) Content data distributing system, content data distributing method, and commodity selling method

(75) Inventors: Akihiro Kasahara, Chiba (JP); Akira Miura, Kanagawa (JP); Hiroshi Suu, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/573,246

(22) PCT Filed: Jun. 24, 2005
(86) PCT No.: PCT/JP05/11613

§ 371 Date: Feb. 6, 2007

(30) Foreign Application Priority Data
Aug. 6, 2004 (JP) 2004-230251

(51) Int. Cl. G06Q 99/00; H04L 9/00; H04K 1/00; H04L 9/32; G06F 12/14; G06F 17/30; G06F 7/04; G06F 11/30; G06K 9/00; H03M 1/68; H04N 7/16

(52) U.S. Cl. 705/51; 705/52; 705/57; 705/59; 726/27; 713/189

(57) ABSTRACT

When settling a purchase price, a troublesome input is omitted and an input mistake or the like is prevented. The content data delivery server 42 makes the QR code generation unit 49 generate a QR code including encoded URL data of the settlement unit 70, a medium identifier data IDm and so forth. The QR code is displayed on a display 26.

After imaging the displayed QR code by a CCD camera 58, the QR code is analyzed and a data is read therefrom. It is transmitted to a settlement server 71 and a settlement request is performed.

### FIELD OF THE INVENTION

This invention relates to a content data delivery system, a content data delivery method, and a method for selling products.

### BACKGROUND OF THE INVENTION

In recent years, with development of information society, a content data distribution system is widely used. In this system, the content data including electronic data such as a book, newspaper, music, or an moving pictures, is distributed to a user terminal, which enables browsing of content data in the user terminal.

However, since electric content data (heretofore, it is referred to as “content data”) can be copied easily, the electronic content data tends to induce illegal acts that disregard copyright. From a viewpoint of protecting content data from such an illegal act, content data is encrypted and recorded by the encryption key and is usually decoded at the time of reproducing.

Content data protection technologies like this include CPRM (Content Protection for Prerecorded Media) which uses a standardized encryption key scheme in SD audio, SD video, SD E-e-Publish (SD computer-assisted publishing) or the like (for example, refer to nonpatent literature 1). The encryption-key scheme adapted in this nonpatent literature 1 is an encryption single key scheme which enciphers a title key with a medium unique key. On the other hand, the encryption double key scheme in which the content key is doubly encrypted with the user key and the medium unique key is known (for example, refer to nonpatent literature 2). This kind of encryption double key scheme is used in MQbic (registered trademark), for example.

FIG. 6 is a schematic diagram showing the configuration of the SD card and a user terminal corresponding to the encryption double key scheme adopted in Mqbic. An SD card SDq is an example of a secure storage medium which securely stores data. The SD card SDq has a system area 1, a hidden area 2, a protection area 3, a user data area 4, and an encryption/decryption unit 5, and the data is stored in each area 1-4.

In a SD card SDq like this, key management information MKB (Media Key Block) and the medium identifier IDm are stored in the system area 1. The medium unique key Kmu is stored in the hidden area 2. The encrypted user key Enc (Kmu, Ku) is stored in the protection area 3, and the encrypted content key data Enc (Ku, Kc) is stored in the user data area 4. The expression of Enc (A, B) means the data B encrypted with data A in this specification. Here, the user key Ku is encryption/decryption key to the content key Kc, and is used in common also to two or more encrypted content key data Enc (Ku, Kc1), Enc (Ku, Kc2). . . . Moreover, the subscript q of the SD card SDq denotes that it conforms to MQbic (registered trademark).

Here, the system area 1 is a read-only area which can be accessed from outside of the SD card. The hidden area 2 is a read-only area that the SD card itself refers to, and cannot be accessed at all from external. The protection area 3 is an area in which data read and write is possible from external of the SD card when authentication is accomplished.

The user data area 4 is an area in which read/writing is freely possible from outside of the SD card. The encryption/decryption unit 5 performs authentication, key exchanging, and cryptography, and has a function of encryption/decryption.

The user terminal 20q for reproducing operates logically as follows to such the SD card SDq. That is, the user terminal 20q, performs MKB processing of the key management information MKB read from the system area of the SD card SDq with the device key Kd set up beforehand (S1), to obtain a medium key Km. Next, the user terminal 20q carries out the hash processing of both the medium key Km and the medium identifier IDm read from the system area 1 of the SD card SDq (S2), and obtains the medium unique key Kmu.

Thereafter, the user terminal 20q performs, based on the medium unique key Kmu, an authentication process and a key exchanging process (AKE: Authentication Key Exchange) with the decryption/encryption unit 5 of the SD card SDq, to share a session key with the SD card SDq (S3).

Note that the authentication and key exchanging process in the step S3 succeeds when the medium unique key Kmu in the hidden area 2 referred to at the decryption/encryption unit 5 coincides with the medium unique key Kmu generated by the user terminal 20q, thereby the session key Ks being shared.

Then, the user terminal 20q reads out the encrypted user key Enc (Kmu, Ku) from the protection area 3, through a cipher communication using the session key Ks (S4). This results in the encrypted user key Enc (Kmu, Ku) being decrypted by the medium unique key Kmu (S5). Then, the user key Ku will be obtained.

Finally, when the encrypted content key Enc (Ku, Kc) is read from the user data area 4 of the SD card SDq, the user terminal 20q carries out the decryption processing of the encrypted content key Enc (Ku, Kc) with the user key Ku to obtain a content key Kc (S5q) Finally, when the encrypted content data Enc (Kc, C) is read from a memory 11q, the user terminal 20q performs the decryption processing of the encrypted content data Enc (Kc, C) with the content key Kc (S6). Thereby, the user terminal 20q reproduces the obtained content data C.

Note that although the above-mentioned example stores encrypted content data in the memory 11q of the user terminal 20q, it may be stored in the external storage medium.

The above-mentioned encryption double key scheme stores encrypted content key data at the user data area 4 having a large memory capacitance compared to the protection area 3. Therefore, it has an advantage in that it can store a lot of encrypted content key data compared to encryption single key scheme.

Moreover, since the encryption double key scheme may store encrypted content data in the SD card, it may urge the distribution of encrypted content data.

Furthermore, in the encryption double key scheme, the medium identifier as an identifier is given to each SD card, and a unique user key is issued per medium identifier This user key is also encrypted and stored in the protection area (protected area) of an SD card. Encryption of the user key depends on the medium identifier, and the user key can be decoded only with a authentic player. For this reason, content data cannot be acquired even if a trespasser copies only a content key unjustly from a user data area.

When settling purchase price of content data in the content data distribution system using such an encryption double key scheme like this, the settlement procedure have to be performed by inputting a credit card number, a user's address a user's name or the like.

In the catalog shopping based on printed matters, a system is known in which information or the like needed to be input for the settlement is printed as a barcode on a catalog or the like, and a user reads it by a reader so that the input procedure may be omitted This is known for example in patent literature 1. In an online distribution system at present, however, these kinds of information are still input by a keyboard or the like. Such input may not only be troublesome, but it may produce an input mistake or the like.

[Nonpatent literature 1] 4C An entity, LLC, [online], Internet <URL: http/www.4Centity.com/, searched on Jun. 14, 2004>

[Nonpatent literature 2] IT information site and ITmedia news [online], Internet<URL:http://wwwitmedia.co.jp/news/0307/18/njbt_{—}02. html searched on Jun. 14, 2004>

[Patent literature 1] JP 2003-233546 A

### DISCLOSURE OF THE INVENTION

[Problem to be Solved]

An object of the present invention is to provide a content data delivery system a content data delivery method and a method for selling products that can omit a troublesome input and can prevent an input mistake or the like.

### SUMMARY OF THE INVENTION

The content data delivery method according to the present invention comprises: a delivery request step transmitting a delivery request of content data to a content data delivery unit from a first user terminal operated by a user who owns a storage medium; a code information generating and transmitting step in which the content data delivery unit generates code information indicating at least URL data of a settlement unit in charge of settling a purchase price of the content data, and content information specifying the content data concerning the delivery request, and transmits the code information to the first user terminal; an displaying step displaying the code information in a display unit of the first user terminal; an imaging step imaging the displayed code information by an image pickup unit cooperated with a second user terminal, a analyzing step analyzing the imaged code information and restoring the URL data and the content information; a settlement requesting step accessing the settlement unit from the second user terminal designating the URL data obtained by the analyzing step, and transmitting a settlement request to the settlement unit, submitting at least user specification data specifying the user and the content information acquired by the analyzing step; settlement executing step executing settlement for the user specified by the user specification data; and a reporting step reporting to the content data delivery unit that the settlement request has been made by the specified user.

The content data delivery system according to the present invention comprises a content data delivery unit delivering content data in response to the content data delivery request from a user, and a settlement unit for settling a purchase price of the content data. The content data delivery unit is configured such that it may be connected to a first user terminal owned by the user. The settlement unit is configured such that it may be connected to a second user terminal owned by the user and cooperated with an image pickup device for imaging an image In addition, a storage medium being configured such that it may be connected to the first user terminal or the second user terminal.

The content data delivery unit comprises a transmitter/receiver that receives the content data delivery request from the first user terminal and transmits the various kinds of data containing the content data, and a code information generation unit generating the code information indicating at least URL data of the settlement unit and content information specifying the content data.

The settlement unit comprises a user database holding user specification data specifying the user as an owner of a storage medium, transmitter/receiver that transmits, when it is confirmed that the content information extracted from the image of the code information imaged by the image pickup device has been received from the second user terminal as a settlement request with the user specification data, confirmation information thereof to the content data delivery unit, and a settlement execution unit that executes settlement referring to the user database, based on the user specification data and the content information included in the settlement request.

A method for selling products according to the present invention comprises: a request step transmitting a purchase request of a specific product searched by the a user out of plural products, from a first user terminal with a product search function to a product sale unit; a code information generating and transmitting step in which the product sale unit generates code information indicating at least URL data of a settlement unit in charge of settling a purchase price of the product, and product information specifying the product concerning the purchase request, and transmitting the code information to the first user terminal; a display step displaying the code information in a display unit in the first user terminal; an imaging step imaging the displayed code information by an image pickup unit cooperated with a second user terminal; an analyzing step analyzing the imaged code information and restoring the URL data and the product information; a settlement request step accessing the settlement unit from the second user terminal designating the URL data obtained by the analyzing step, and transmitting a settlement request to the settlement unit, submitting at least user specification data specifying the user and the specified product information acquired by the analyzing step; a settlement execution step executing settlement for the user specified by the user specification data; and a reporting step reporting to the product sale unit that the settlement request has been made by the specified.

[The Advantage of the Present Invention]

According to this invention, when settling a purchase price, code information is generated, and it is displayed on a display of the first user terminal. Using uniform resource locator (URL) of the settlement unit obtained by imaging and analyzing the displayed code information, the second user terminal accesses a settlement unit In addition, it transmits a settlement request to the settlement unit submitting user specification data or the like. Therefore, a troublesome input can be omitted and an input mistake or the like may be prevented.

### EMBODIMENTS

Hereafter, embodiments of the present invention will now be described with reference to the drawings FIG. 1 is a diagram showing the configuration of the content data delivery system relating to the embodiment of the present invention.

The same numerals are given to the same parts as FIG. 6, and detailed explanation is omitted for these parts. Different parts are hereafter mainly described.

The content data delivery system of this embodiment is configured such that a first user terminal 20 holding a SD card SDq freely attachable and detachable therein, is enabled to communicate through a network 30 to a data delivery unit 40.

The first user terminal 20 here is a personal computer connectable with the Internet. It has a CPU 21, a ROM 22, a RAM 23, a hard disc drive 24, a display control unit 25, a display 26, a interface 27, and a communication control unit 28 Since these members 21-28 are the same as those in a common personal computer, a detailed explanation thereof is omitted. In addition, software such as a WWW browser, are installed in the hard disc drive 24

The data delivery unit 40 receives the delivery request of content data from the first user terminal 20, and has a function of distributing the content data C concerning the request, content key data Kc for encrypting the content data C and so forth to the user terminal 20 through a network 30 The data delivery unit 40 comprises a key delivery server 41, a content data delivery server 42, a medium identifier database 43, a user key database 44, a content key database 45, a authenticated content ID database 46, a content database 48, a QR code generation unit 49, a hash-value generation unit 50, and a security module 51.

The key delivery server 41 has a function of responding to the delivery request of content data from the first user terminal 20, and distributing content key data Kc of the content data, and a user key Ku used in a SD card SDq as a requester The content data delivery server 42 receives the delivery request of content data from the first user terminal 20, and has a function of extracting this content data from the content database 48, and distributing it after encryption thereof

The medium identifier database 43 holds the medium identifier data IDm owned by each SD card. The user key database 44 holds user key data Ku owned by each SD card. The content key database 45 holds various content key data.

The authenticated content ID database 46 holds data of the content key data issued according to the request of users, as being related to the medium identifier IDm of the SD card. The content database 48 holds various kinds of content data C which should be distributed according to the request from a user.

The QR code generation unit 49 has the function of converting, in response to the delivery request of content data, the content data itself concerning a request, and various kinds of data relating to an obtaining procedure into a QR code. A QR code is a kind of a two-dimensional code, and is a scheme introduced by Denso Corporation in 1997 (see the http://qrcode.com etc, for details).

In this embodiment, the followings are encoded by a QR code.
(1) URT data of a settlement unit 70 which is described later
(2) Medium identifier data IDm of a SD card SDq
(3) Content information relating to content data concerning a delivery request (a content ID, a number of pieces, and existence/non-existence of options, and content of options)
(4) The seller ID of a seller selling content data concerning a delivery request
(5) A QR code number
(6) A date when a QR code is generated
(7) An expiry term of the QR code
(8) A Hash value of the data of (1)-(7)

Note that although a QR code is used as a two-dimensional code in this embodiment, it is needless to say that other two-dimensional codes, for example, a stacked barcode (introduced by Symbol Corp. (U.S.)), Vericode (introduced by VERITEC Corp. (U.S.)), Data Matrix (introduced by ID.MATRIX Corp. (U.S.)) and so forth may be used. Moreover, as long as there is little information quantity of the information to be encoded, a conventional barcode may be used instead of a two-dimensional code

It is needless to say that (1)-(7) enumerated above can be replaced by other data of the same kinds For example, since (2) the medium identifier data IDm is data for specifying a user for settlement, other data for specifying a user may be used (i.e. a cellular phone number, a user's bank account number, an user ID, etc.) Furthermore, if it is a data useful for a settlement procedure, it is also possible to add other data than (1)-(7).

The generated QR code is converted into image data, such as bitmap data and GIF data, for example. Thereafter, it is transmitted to the first user terminal 20 through the network 30. The QR code as image data received in the communication control unit 28 as a transmitter/receiver is displayed on a display 26 in response to a certain display process by the display control unit 25.

The hash-value generation unit 50 has a function of generating (8) a hash value By generating a hash value and let it included in a QR code, falsifications of QR codes by malicious third parties are prevented, thereby a user being prevented from troubles, such as paying for the content data purchased by others by mistake.

The security module 51 is a unit that performs encryption/decryption processing of the user key Ku and the content key Kc, and is equipped with a management key obtaining unit 52, and a key encryption management unit 53.

The management key obtaining unit 52 holds the management key readable from the key delivery server 41.

The key encryption management unit 53 has a function of receiving a setup of a management key by the key delivery server 41, decoding the encrypted user key for management and the encrypted content key for management respectively, which are received from the key delivery server 41 based on the management key to obtain a user key and a content key, encrypting the content key and basic metadata with the user key, and transmitting to the delivery server 41 the encrypted content key (with basic metadata included therein) obtained and (additional) metadata such as a purchase date or the like.

In this embodiment, each user owns the first user terminal 20, as well as a second user terminal 60 The second user terminal 60 is enabled to be connected to the settlement unit 70 through the network 30, and is configured to execute a settlement procedure about the purchase procedure of content data performed by the first user terminal 20. Typically, this second user terminal 60 is a mobile phone with a camera, and is equipped with a control unit 61, a storage medium 62, a ROM 63, a RAM 64, a communication control unit 65, a display control unit 66, a display 67, a CCD camera 68, an interface 68A, and a QR code analysis unit 69. Since the components 61-68 are the sa e as those of a usual portable cellular phone, a detailed illustration is omitted herein. In addition, software such as a WWW browser, is installed in ROM 63, and is started by the control unit 61 suitably. In addition, although a camera-equipped mobile phone is suitable as the second user terminal 60, a mobile phone without a camera but with a function of capturing images imaged by a digital camera as another device may be adapted, for example. The QR code analysis unit 69 analyzes the QR code imaged by the CCD camera 68, and obtains various data included in the QR code.

The settlement unit 70 is equipped with a settlement server 71 connected to the content data delivery server 42 through the network 30 The settlement server 7 transmits and receives to and from content data delivery servers 42 the hash values in order for information about settlement request and for confirming identification of hash values, as described later. Moreover, this settlement server 71 is in cooperation with the user account database 72 storing data of each user's bank account, and a seller account database 73 storing data of each seller's bank account. Furthermore, the settlement server 71 is equipped with a user database 74 storing data indicating relationships between a medium identifier data IDm of an SD card SDq and an owner of the SD card.

Next, the operation in the delivery and settlement of content data in this embodiment is explained with reference to FIG. 2.

First, a user searches content data information offered by the data delivery unit 40 using the first user terminal (a personal computer) 20. If the content data C which the user wishes to purchase is found, the user requests to the content data delivery server 42 a download of the encrypted content data C (S11) The content data delivery server 42 encrypts the content data C by the content key data Kc, and transmits it to the first user terminal 20 (S12).

At this point of time, browsing of the content data C cannot be performed because the content key data Kc is not obtained yet at the first user terminal 20.

Subsequently, the user presents the medium identifier data IDm of the SD card SDq, and the content ID of the distributed content data C, and requests the purchase of the content key data Kc from the first user terminal 20 (S13) The content data delivery server 42 which received this request requests the user to select payment systems (a bank transfer, a credit card, a portable cellular phone, etc.) (S14).

If the user replies that he chooses the settlement by a portable cellular phone here (S15), the content data delivery server 42 makes the QR code generation unit 49 generate the QR code in which the data of above-mentioned (1)-(8) is encoded for example, and transmits it to the first user terminal 20 as an image file (S16). The first user terminal 20 displays the image of the received QR code on the display 26 (S17).

Next, the user images the QR code displayed on the display 26 using the CCD camera 68 of the second user terminal 60, and inputs it into the second user terminal 60 as an image data (S18). In the second user terminal 60, the QR code is analyzed by the QR code analysis unit 69, thereby above-mentioned data (1)-(8) contained in the QR code being read.

Next, using (1) the URL data of the settlement unit 70, the second user terminal 60 accesses the settlement unit 70 and transmits above-mentioned data (2)-(8) to the settlement server 71, and performs a settlement request (S19).

If the settlement request is received with various data (2)-(8), the settlement server 71 extracts the content ID and the price data, and transmits the data to the second user terminal 60 for a confirmation (S20). The user looks at this on the display 67, and replies to the settlement server 71 that he or she has checked there is no error (S21). This check prevents false selling and buying of content data from being performed due to data-falsification by a malicious third parties or a user's input mistake or the like.

When a report of the confirmation accomplishment is received from the second user terminal 60, the settlement server 71 transmits the confirmation information indicating that to the content data delivery server 42 (S22). The content data delivery server 42 which received confirmation information requests the key delivery server 41 to deliver the content key data Kc corresponding to the medium identifier data IDm presented by the second user terminal 60 (S23).

The key delivery server 41 rewrites the authenticated content ID database 46 to record as data that the right about the new content data C is generated for the user of the second user terminal 60 (S24). If this rewriting is completed, the key delivery server 41 transmits a notification to the content data delivery server 42 to show that a right generation has been completed (S25).

The content data delivery server 42 transfers this right generation completion notice to the first user terminal 20, and urges it to perform a right update request (S26).

If a right update request is transmitted towards the key delivery server 41 from the first user terminal 20 (S27), the key delivery server 41 transmits the content key data Kc encrypted with the user key Ku, toward the SD card SDq inserted in the first user terminal 20 (S28). Thereby, in the first user terminal 20, usage of the content data C concerning delivery request is made possible. Then, the key delivery server 41 transmits a notification indicating that the delivery of the encrypted content key data Kc has been completed, to the content data delivery server 42 (S29).

The content data delivery server 42 transmits a settlement request to the settlement server 71, when this notification has been received (S30). The settlement server 71 specifies a user referring to the user database 71 based on the medium identifier data IDm. In addition, it specifies the user's account, and a seller's account from an account database to perform settlement thereof (S31).

If a settlement procedure is completed, the settlement completion notification indicating that is transmitted to the second user terminal 60 (S32), and all the procedures are completed.

In addition, in either S22, or S23-S29, if necessary, it is suitable to check identification of the hash value in the QR code transmitted by the content data delivery server 42, and the hash value received by the settlement server 71. Thereby, a user can be protected from a falsification by a malicious third parties.

Thus, according to this embodiment, the first user terminal 20 such as a personal computer performs a delivery request. Moreover, the QR code offered from the content data delivery server 42 is imaged and analyzed by the second user terminal 60 such as a camera-equipped mobile phone, and a settlement procedure is performed by transmitting the content information to the settlement unit 70.

For this reason, a user is free from the input procedure of settlement data for a settlement procedure, and also free from his possibility of making input mistakes or the like.

Moreover, since the medium identifier data IDm as personal information, the content ID as goods purchase information and the like are encoded by a QR code, security improves.

Moreover, purchase/settlement procedures of content data can be performed more smoothly, by using a terminal such as a personal computer as the first user terminal 20, in which an information input and a viewing thereof is easily performed, and by using a terminal such as such as a cellular phone as the second user terminal 60, in which settlement can be performed easily and safely.

Furthermore, by including various kinds of information about the content data concerning a delivery request in the QR code, an operation of the second user terminal 60 can be simplified, and troubles such as mistaking purchase goods, can be lessened.

Next, the content data delivery system concerning the second embodiment of the present invention is explained with reference to FIG. 3. As illustrated in FIG. 3, this embodiment is different from the first embodiment in that the SD card SDq is inserted in the second user terminal 60, and in that the content data and the content key data are stored in the second user terminal 60 and the SD card SDq, respectively.

Since the configurations of the first user terminal 20, the data delivery unit 40, the second user terminal 60, and settlement unit 70 grade are the same as those of the first embodiment, detailed illustrations thereof are omitted.

Next, operations of the delivery of content data and settlement in the content data delivery system concerning the second embodiment are explained with reference to FIG. 4.

The procedure in S41-S48 is the same as that of S11-S18 in FIG. 2. However, in this embodiment, since the SD card SDq is inserted in the second user terminal 60, the encrypted content data C received at the first user terminal 20 is transferred (copied) to the second user terminal 60 in S42.

Moreover, since the first user terminal 20 does not have the medium identifier data IDm, the medium identifier data IDm is not transmitted but only the content ID is transmitted in the purchase request of the content key data in S43, unlike S13 in FIG. 2. Therefore, the medium identifier data IDm is not included in the QR code generated by S46.

The second user terminal 60 reads the medium identifier data IDm from the SD card SDq connected to itself, after the analysis of the QR code, and transmits it to the settlement unit 70 with the data contained in the QR code (S49). Since steps S50-S63 are the same as the steps S20-S32 shown in FIG. 2, a detailed illustration thereof is omitted

Next, the content data delivery system according to a third embodiment of the present invention is explained with reference to FIG. 5 The configuration of this embodiment is the same as that of the second embodiment shown in FIG. 3 However, this embodiment is different from the above-described embodiments in that encrypted content data is not delivered immediately just after the purchase request (S71) of the content key data Kc is performed. That is, in this embodiment, a QR code is generated displayed imaged (S74-76) Then, after a user performs a settlement request from the second user terminal 60, an encrypted content data is transmitted to the second user terminal 60 (S80). Others are almost the same as those of the above-mentioned embodiments

Note that the process described in each of above-mentioned embodiments can be implemented by a program which can make a computer perform the process. The program can be stored in a storage medium such as magnetic disks (a floppy (registered trademark) disk, a hard disk etc.) an optical disk (CD-ROM, DVD etc.), a magneto-optical disk (MO), and a semiconductor memory.

Moreover, as this storage medium scheme for storing may be of any type, as long as it is a storage medium enabled to store a program readable by a computer.

Moreover, operating system (OS) working on a computer based on an indication of the program installed in the computer from the storage medium, a database management software, and a middleware such as network software, can implement part of the processes for realizing the embodiments

Furthermore, the storage medium in the present invention is not limited to the medium that is independent of a computer. It may be a storage medium that downloads the program transmitted by a local area network (LAN) or the Internet, etc and stores or temporarily stores it.

Moreover a storage medium is not limited to a single one. When the processes in the embodiments are performed by a plurality of media the media are included in the storage medium according to the present invention In addition the medium configuration cay be any type.

Note that a computer in the present invention is configured to perform each process in the embodiments based on a program stored in a storage medium It may have any configurations. For example, it may be a single device such as a personal computer, or a system having a plurality of network-connected computers.

Moreover, a computer in the present invention is not limited to a personal computer, but includes a operation processing device included in a information processing device, and a microcomputer. It includes devices or apparatuses that can realize the function of the present invention by a program

Although a system for selling and delivering content data has been explained above, the present invention may be expanded to an online sale system for general products Specifically, it is possible to construct a system executing the following steps (1)-(7).
(1) A user searches products in the first user terminal 20 (personal computer etc.) connected to the Internet, and transmits a purchase request of the a specific product searched by the user among plural products to a sale server.
(2) A sale server generates the URL data of a settlement unit, and the QR code indicating product information, and transmits it to the first user terminal 20.
(3) The QR code is displayed on the display of the first user terminal 20.
(4) The displayed QR code is imaged by the image pickup units (i.e. a CCD camera or the like) cooperated with the second user terminals 60 (i.e. a cellular phone or the like). The settlement unit 70 specified by the URL obtained by analyzing the imaged QR code information is accessed from the second user terminal 60.
(5) While presenting user information with the product information acquired by analyzing the QR code, a settlement request is transmitted to the settlement unit.
(6) Settlement is performed for the user specified by user information.
(7) A report indicating that a settlement request has been performed is sent to the sale server The sale server which received the information completes dispatching of purchased products.

It differs from the content data delivery system in the method of shipping products, the subsequent storing method or the like. However, it has the same advantage in that a QR code contributes to simplification of input operation.

Note that the present invention is not limited to the above-described embodiments themselves. In a practice phase, their components can be modified and embodied, as long as it does not depart from the spirit thereof. Moreover, merging two or more proper components indicated by the above-mentioned embodiments can form various inventions For example, some components may be deleted from all the components shown in the embodiments Furthermore, the components employed in different embodiments may be combined suitably.

### BRIEF EXPLANATION OF THE DRAWINGS

FIG. 1 is a schematic diagram illustrating a configuration of a content data delivery system according to a first embodiment of the present invention.

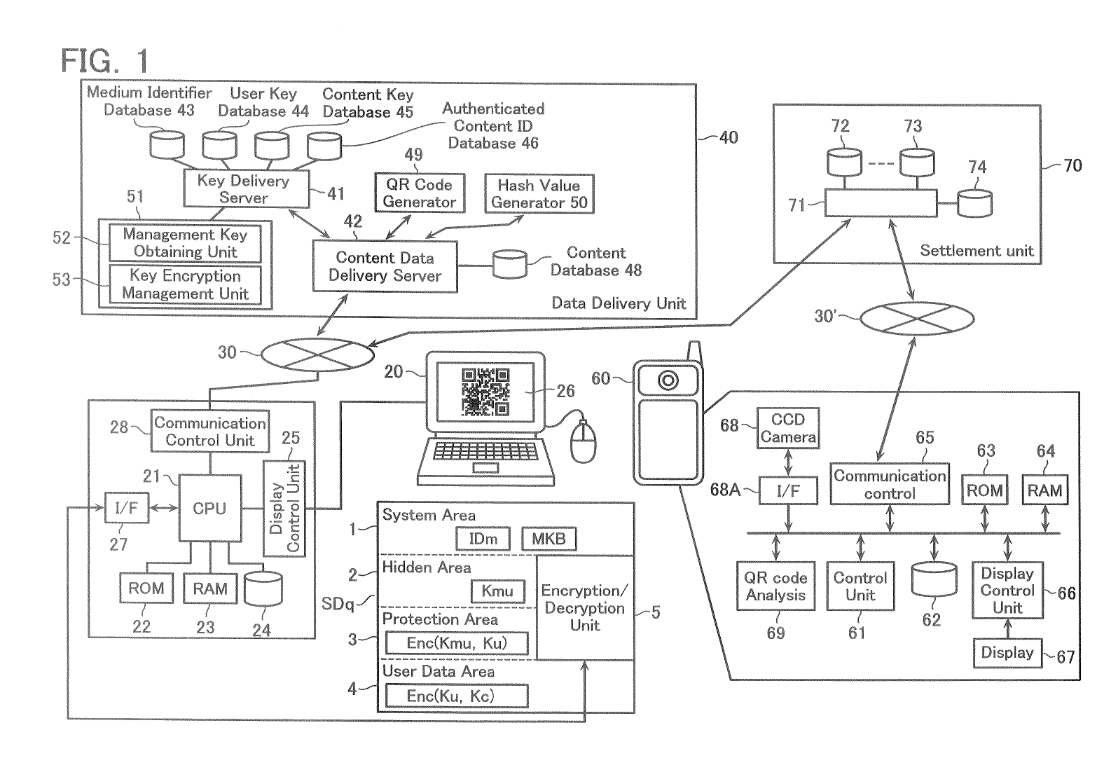

FIG. 2 explains operations relating to the delivery and settlement of content data in the first embodiment.

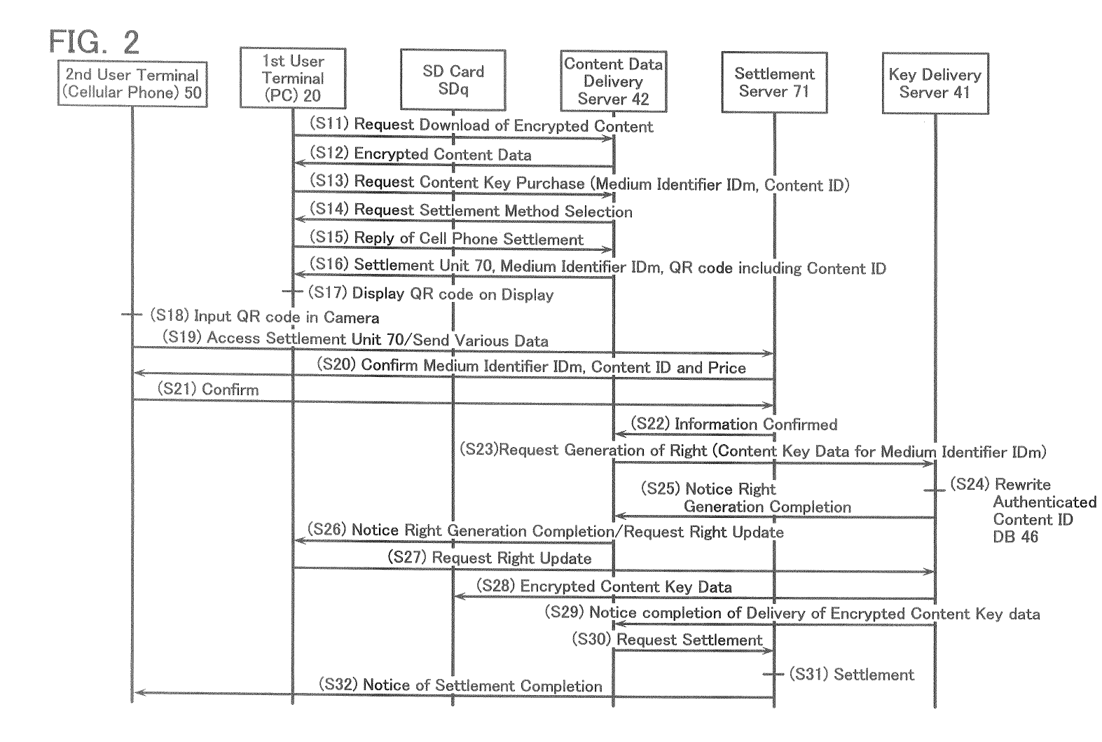

FIG. 3 is a schematic diagram illustrating a configuration of a content data delivery system according to a second embodiment of the present invention.

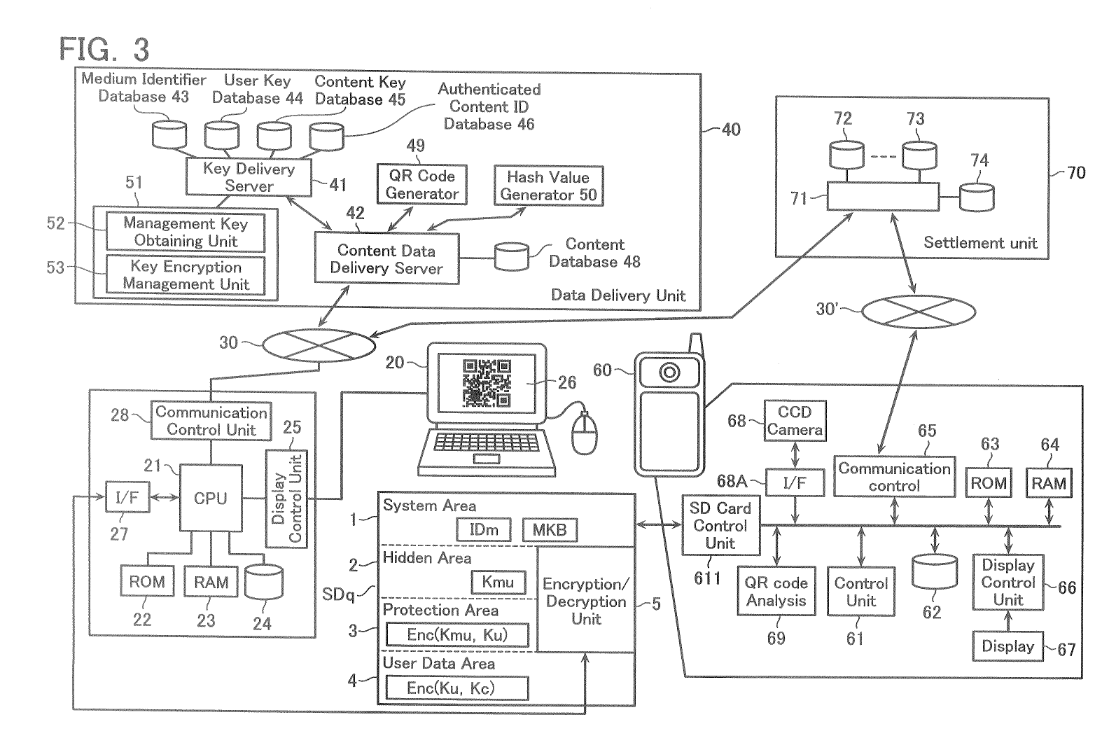

FIG. 4 explains operations relating to the delivery and settlement of content data in the second embodiment.

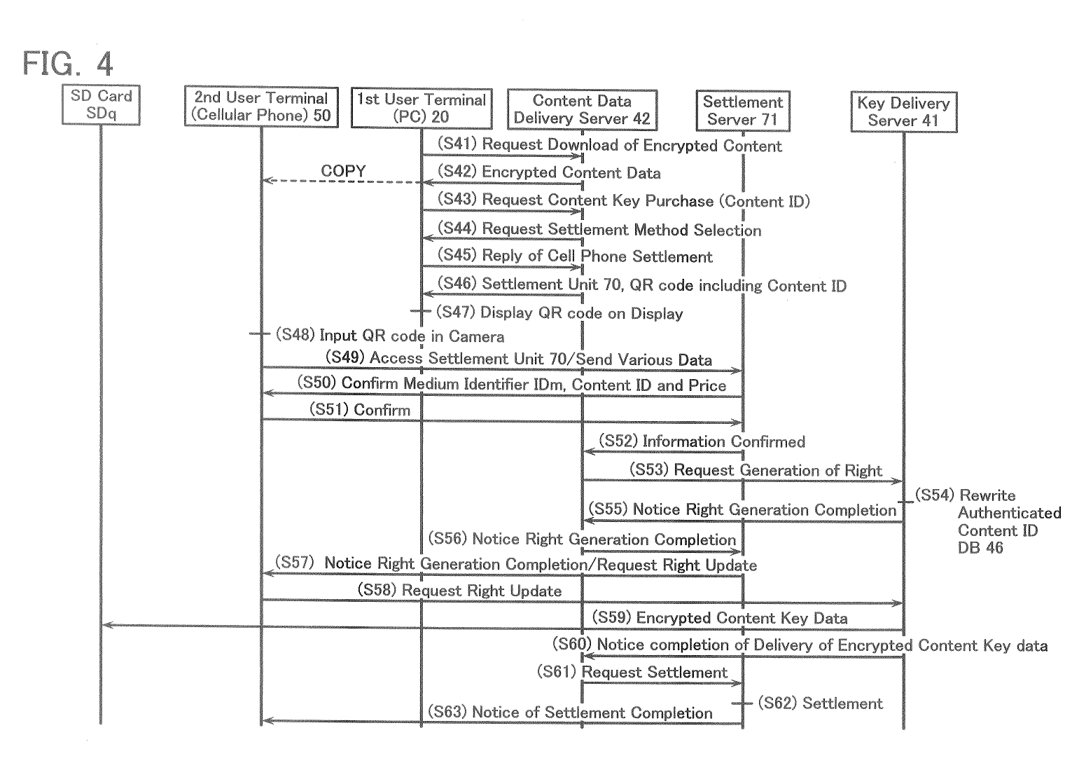

FIG. 5 explains operations relating to the delivery and settlement of content data in the third embodiment.

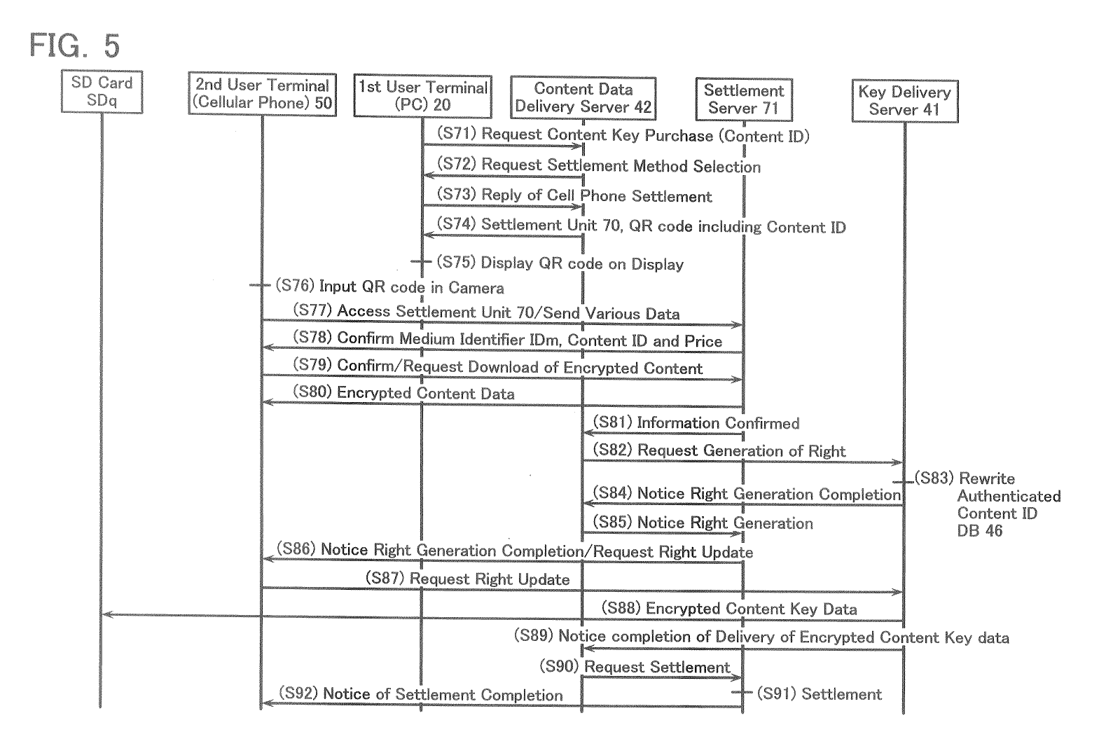

FIG. 6 is a diagram showing the configuration of the SD card and a user terminal conforming to the encryption double key scheme adopted in MQbic

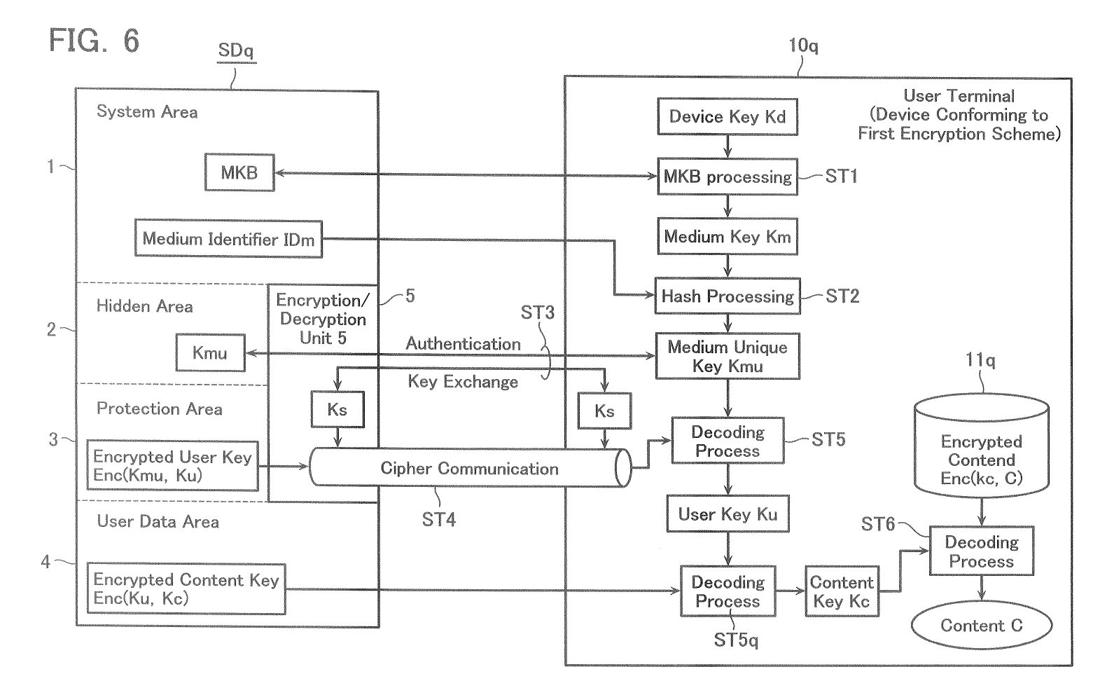

[An Explanation of Symbols]

Sdq . . . an SD card
1 . . . a system area
2 . . . a hidden area
3 . . . a protection area
4 . . . a user data area
5 . . . a encryption/decryption unit
20 . . . a first user terminal
40 . . . a data delivery unit
60 . . . a second user terminal
70 . . . a settlement unit

1. A content data delivery method comprising:
a delivery request step transmitting a delivery request of content data to a content data delivery unit from a first user terminal operated by a user who owns a storage medium;
a code information generating and transmitting step in which the content data delivery unit generates code information indicating at least URL data of a settlement unit in charge of settling a purchase price of the content data, and content information specifying the content data concerning the delivery request, and transmits the code information to the first user terminal;
an displaying step displaying the code information in a display unit of the first user terminal;
an imaging step imaging the displayed code information by an image pickup unit cooperated with a second user terminal,
a analyzing step analyzing the imaged code information and restoring the URL data and the content information;
a settlement requesting step accessing the settlement unit from the second user terminal designating the URL data obtained by the analyzing step, and transmitting a settlement request to the settlement unit, submitting at least user specification data specifying the user and the content information acquired by the analyzing step;
a settlement executing step executing settlement for the user specified by the user specification data; and
a reporting step reporting to the content data delivery unit that the settlement request has been made by the specified user.

2. The content data delivery method according to claim 1, wherein the content data delivery unit is configured such that a delivery of the content data is completed after receiving the report by the reporting step.

3. The content data delivery method according to claim 1, wherein the code information generating and transmitting step encodes the user specification data as the code information.

4. The content data delivery method according to claim 1, wherein the code information generating and transmitting step encodes hash values of various kinds of data as the code information.

5. The content data delivery method according to claim 4, further comprising a step in which the content data delivery unit and the settlement unit check identification of the hash value transmitted by the content data delivery unit, and the hash value received by the settlement unit.

6. A content data delivery system comprising:
a content data delivery unit delivering content data in response to the content data delivery request from a user; and
a settlement unit for settling a purchase price of the content data,
the content data delivery unit being configured such that it may be connected to a first user terminal owned by the user,
the settlement unit being configured such that it may be connected to a second user terminal owned by the user and cooperated with an image pickup device for imaging an image,
a storage medium being configured such that it may be connected to the first user terminal or the second user terminal,
wherein the content data delivery unit comprises:
a transmitter/receiver that receives the content data delivery request from the first user terminal and transmits the various kinds of data containing the content data; and
a code information generation unit generating code information indicating at least URL data of the settlement unit and content information specifying the content data,
and the settlement unit comprises:
a user database holding user specification data specifying the user as an owner of a storage medium;
transmitter/receiver that transmits, when it is confirmed that the content information extracted from the image of the code information imaged by the image pickup device has been received from the second user terminal as a settlement request with the user specification data, confirmation information thereof to the content data delivery unit; and
a settlement execution unit that executes settlement referring to the user database, based on the user specification data and the content information included in the settlement request.

7. The content data delivery system according to claim 6, wherein the content data delivery unit is configured such that a delivery of the content data is completed when the confirmed information has been received.

8. The content data delivery system according to claim 6, wherein the code information is encoded with the user specification data.

9. The content data delivery system according to claim 6, wherein the code information includes hash values of various kinds of data.

10. The content data delivery system according to claim 9, wherein the content data delivery unit and the settlement unit are configured such that they may transmit and receive the hash value transmitted by the content data delivery unit and the hash value received by the settlement unit therebetween, and confirm the identification thereof.

11. A method for selling products comprising:
a request step transmitting a purchase request of a specific product searched by the a user out of plural products, from a first user terminal with a product search function to a product sale unit;
a code information generating and transmitting step in which the product sale unit generates code information indicating at least URL data of a settlement unit in charge of settling a purchase price of the product, and product information specifying the product concerning the purchase request, and transmitting the code information to the first user terminal;
a display step displaying the code information in a display unit in the first user terminal;
an imaging step imaging the displayed code information by an image pickup unit cooperated with a second user terminal;
an analyzing step analyzing the imaged code information and restoring the URL data and the product information;
a settlement request step accessing the settlement unit from the second user terminal designating the URL data obtained by the analyzing step and transmitting a settlement request to the settlement unit, submitting at least user specification data specifying the user and the specified product information acquired by the analyzing step;
a settlement execution step executing settlement for the user specified by the user specification data; and
a reporting step reporting to the product sale unit that the settlement request has been made by the specified.
